(19) United States
(12) Patent Application Publication
(10) Pub. No.: US 2009/0065064 A1
(43) Pub. Date: Mar. 12, 2009

(54) COMPRESSOR TIP GAP FLOW CONTROL USING PLASMA ACTUATORS

(75) Inventors: Scott Christopher Morris, Granger, IN (US); Thomas C. Corke, Granger, IN (US); Joshua D. Cameron, Granger, IN (US)

Correspondence Address: HANLEY, FLIGHT & ZIMMERMAN, LLC, 150 S. WACKER DRIVE, SUITE 2100, CHICAGO, IL, 60606, US

(73) Assignee: THE UNIVERSITY OF NOTRE DAME DU LAC, Notre Dame, IN (US)

(21) Appl. No.: 12/184,854

(22) Filed: Aug. 1, 2008

Related U.S. Application Data
(60) Provisional application No. 60/963,017, filed on Aug. 2, 2007.

(51) Int. Cl. F17D 3/00; F01D 11/08; F01D 25/00

(52) U.S. Cl. 137/2; 415/173.1; 415/182.1

(57) ABSTRACT

A plasma generator for delaying the onset of rotation stall by tip gap flow control in, for example, an axial flow compressor is disclosed. The tip gap flow control system includes a housing surrounding a rotor of blades and having an inner wall. At least one plasma generating device is coupled to the inner wall of the housing and circumscribes at least a portion of the rotor of blades. A power supply is electrically coupled to the plasma generating device such that when the power supply energizes the plasma generating device, the axial momentum of a fluid flow between the inner wall of the housing and the tips of the rotor of blades in increased in the direction of the fluid flow.

### CROSS REFERENCE TO RELATED APPLICATION

This application is a non-provisional application claiming priority from U.S. Provisional Application Ser. No. 60/963,017, filed Aug. 2, 2007, entitled “Compressor Tip Gap Flow Control Using Plasma Actuators” and incorporated herein by reference in its entirety.

### FIELD OF THE DISCLOSURE

The present disclosure relates generally to axial flow devices and more particularly to compressor tip gap flow control using plasma actuators.

### BACKGROUND OF RELATED ART

The safety and efficiency of axial flow fans and compressor, such as, for instance, gas turbine engines are typically limited, in part, by the performance of the compressors which supply high pressure air for combustion. Both the efficiency and the stability of the compressors are oftentimes strongly affected by leakage of fluid (e.g., air) through the gap between the rotating compressor blades and the casing. This leakage flow causes a loss of performance and under certain engine operating conditions can contribute to the onset of rotational stall.

Rotational stall is typically recognized as a local disruption of airflow within the compressor. During stall, the compressor may continue to provide compressed air but oftentimes with reduced effectiveness. Rotational stall may arise when a small proportion of the airfoils experience airfoil stall disrupting the local airflow without destabilizing the compressor. The stalled airfoils create pockets of stagnant air (referred to as “stall cells”) which, rather than moving in the flow direction, rotate around the circumference of the compressor.

A rotational stall may be momentary or may be steady as the compressor finds a working equilibrium. Local stalls substantially reduce the efficiency of the compressor and increase the structural loads on the airfoils in the region affected. In many cases however, the compressor airfoils are critically loaded such that the original stall cells affect neighboring regions and rapidly grow to a complete compressor stall or compressor surge.

Compressor surge is a complete breakdown in compression resulting in a reversal of flow and a violent expulsion of the previously compressed air out the intake, due to the compressor's inability to maintain pressure. A compressor surge will usually occur when a compressor either experiences conditions which exceed the limit of its pressure rise capabilities, or is highly loaded such that it does not have the capacity to absorb a momentary disturbance. In such cases case, a rotational stall will quickly propagate to include the entire compressor. During compressor surge the flow through the compressor can reverse, and in some case, the combustor can blow out the front of the engine, leading to an engine flame out. Recovery from compressor surge typically requires a complete re-start of the engine.

Passive tip flow control is oftentimes at the core of many compressor stall control techniques. For example, a typical passive flow control methods has been to minimize the clearance between the rotor tip and the surrounding casing. However, in order to avoid contact between the blades and the casing, sufficient clearance must be left during normal compressor operations. Another technique for reducing leakage across the blade tips has been to form a recess in the wall of the casing and to extend the rotor blade to be as close to the casing as possible.

### BRIEF DESCRIPTION OF THE DRAWINGS

FIG. 1 is a schematic illustration of an example single dielectric barrier discharge plasma actuator for use in a compressor casing.

FIG. 2 is a longitudinal-sectional view of an example gas turbine engine including the example single dielectric barrier discharge plasma actuator of FIG. 1.

FIG. 3 is an enlarged longitudinal-sectional view of the example gas turbine engine of FIG. 2, including an example arrangement of single dielectric barrier discharge plasma actuators.

FIG. 4A is a partial plan view of an example row or rotor blades showing an example fluid flow at a design mass flow rate.

FIG. 4B is a partial plan view of an example row or rotor blades similar to FIG. 4A, showing an example fluid flow at a design mass flow rate with an example single dielectric barrier discharge plasma actuator energized to produce a plasma.

FIG. 5A is a partial plan view of an example row or rotor blades showing an example fluid flow at a low mass flow rate.

FIG. 5B is a partial plan view of an example row or rotor blades similar to FIG. 5A, showing an example fluid flow at a low mass flow rate with an example single dielectric barrier discharge plasma actuator energized to produce a plasma.

FIG. 6A is a partial plan view of an example row or rotor blades showing an example fluid flow at a very low mass flow rate.

FIG. 6B is a partial plan view of an example row or rotor blades similar to FIG. 6A, showing an example fluid flow at a very low mass flow rate with an example single dielectric barrier discharge plasma actuator energized to produce a plasma.

FIG. 7 is an example illustration of a steady actuation signal and an unsteady actuation signal.

FIG. 8 is schematic of an example actuator circuit for energizing the single dielectric barrier discharge plasma actuator of FIG. 1.

### DETAILED DESCRIPTION

The following description of the disclosed examples is not intended to limit the scope of the disclosure to the precise form or forms detailed herein. Instead the following description is intended to be illustrative of the principles of the disclosure so that others may follow its teachings.

As described above, passive tip flow control, such as, for example, conventional casing treatment slots, may be provided on the inner surface of a compressor casing around the tips of the compressor blades to attempt to extend the stable flow range over which the compressor may operate. However, passive casing treatments affect the tip flow during all stages of operation, i.e., they are always “on” even when not needed. In the present disclosure, casing surface mounted single dielectric barrier discharge plasma actuators are used to actively control the tip clearance flow. The plasma actuators can be flush mounted into the casing, producing little or no effect on the flow when not in use, i.e., turned “off.”

It will be appreciated by one of ordinary skill in the art that while the disclosed examples are directed to a compressor casing for a gas turbine engine, the disclosed tip clearance flow control may be utilized to provide tip clearance flow control to any suitable axial flow device, including, but not limited to, fans, turbines, pumps, jet engines, high speed ship engines, power stations, superchargers, low pressure compressors, high pressure compressors, and/or any other application.

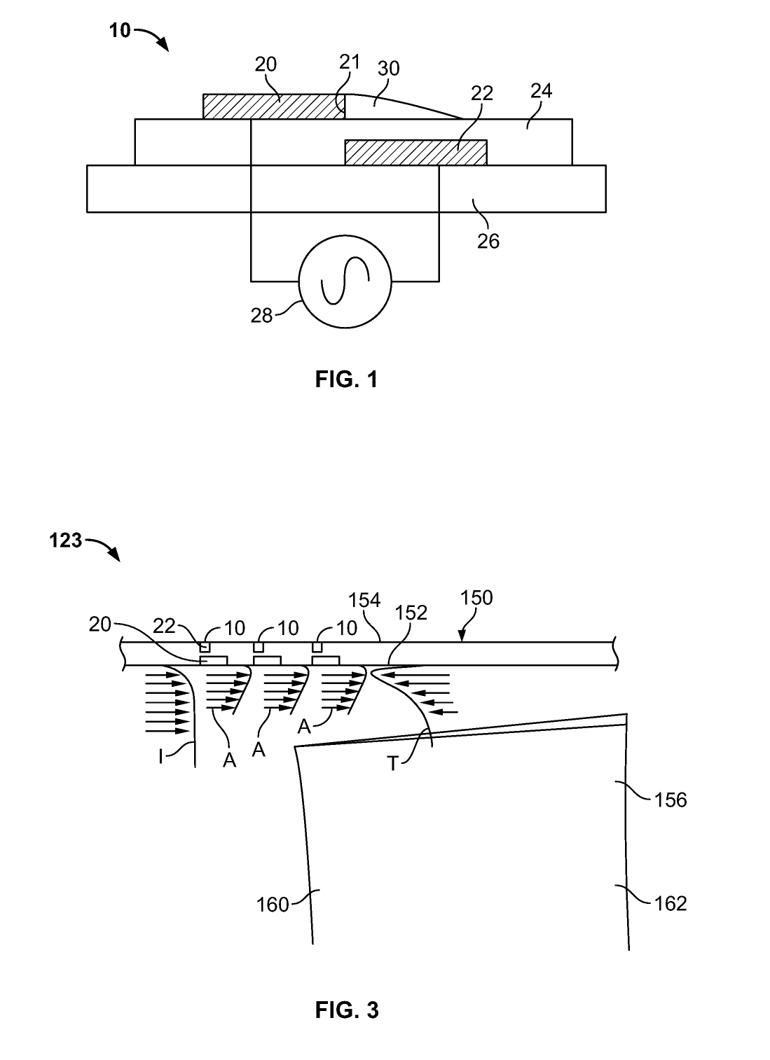

Referring to FIG. 1, an example of a single dielectric barrier discharge (SDBD) plasma actuator 10 is shown. As shown in FIG. 1, a plasma actuator 10 includes an exposed electrode 20 and an enclosed electrode 22 separated by a dielectric barrier material 24. The electrodes 20, 22 and the dielectric material 24 may be mounted, for example, to a substrate 26. A high voltage AC power supply 28 is electrically coupled to the electrodes 20, 22. It will be understood that the exposed electrode 20 may be at least partially covered, while the enclosed electrode may be at least partially exposed. During operation, when the amplitude of the applied AC voltage is large enough, the air will locally ionize in the region of the largest electric field (i.e. potential gradient) forming a plasma 30. The plasma 30 generally forms at an edge 21 of the exposed electrode 20 and is accompanied by a coupling of directed momentum to the surrounding air. For example, the formation of the plasma 30 introduces steady or unsteady velocity components in the surrounding air that form the basis of the disclosed flow control strategies as will be described below.

The induced velocity by the plasma 30 can be tailored through the design of the arrangement of the electrodes 20, 22, which controls the spatial electric field. For example, various arrangements of the electrodes 20, 22 can produce wall jets, spanwise vortices or streamwise vortices, when placed on the wall in a boundary layer. The ability to tailor the actuator-induced flow by the arrangement of the electrodes 20, 22 relative to each other and to the flow direction allows one to achieve a wide variety of actuation strategies for compressor casing treatments.

To maintain the plasma 30, in this example an applied AC voltage from the power supply 28 is required. In the illustrated example, the plasma 30 can sustain a large volume discharge at atmospheric pressure without arcing because it is self-limiting. In particular, during the half-cycle for which the exposed electrode 20 is more negative than the surface of the dielectric 24 and the covered electrode 22, and assuming a sufficiently large potential difference, electrons are emitted from the exposed electrode 20 and terminate on the surface of the dielectric 24. The buildup of surface charge on the dielectric 24 opposes the applied voltage and gives the plasma 30 discharge its self-limiting character. That is, the plasma 30 is extinguished unless the magnitude of the applied voltage continuously increases. On the next half-cycle, the charge available for discharge is limited to that deposited on the dielectric surface during the previous half-cycle and the plasma 30 again forms as it returns to the exposed electrode 20.

As described above, although passive casing treatments can delay the onset of rotational stall, the need to manipulate the blade tip clearance flow may be transient in nature. For example, the need to manipulate the blade tip clearance flow may be greatest during times of compressor stress (i.e., low mass flow rates), such as, for example, during take-off and/or landing of a jet aircraft. In the present disclosure, surface mounted SDBD plasma actuators 10 are used to control compressor rotor blade tip clearance flow by active means. The plasma actuators 10 may be flush mounted to wall surrounding the blade, producing little or no effect on flow through the compressor when not actuated. In other words, the plasma casing treatment will not cause a loss in design operating point efficiency. Furthermore, the plasma casing treatment may by implemented in an open or closed loop for control of rotating stall. An example open loop implementation energizes or de-energizes the plasma actuator based upon the corrected speed and corrected mass flow of the compressor. An example closed loop implementation utilizes a sensor or sensors to monitor the compressor aerodynamics, synthesizing a stability state variable. The plasma actuators are selectively energized or de-energized to drive the fluid flow away from stall.

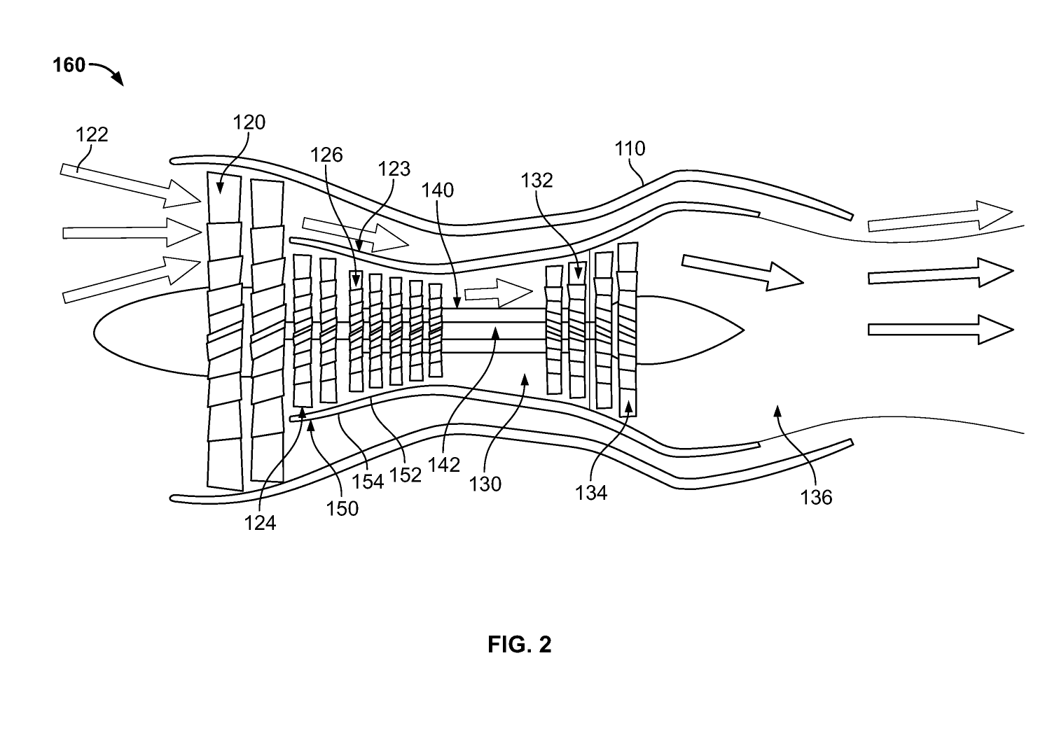

Referring now to FIG. 2, an example gas turbine engine 100 is shown. The engine 100 generally includes a housing 110, a fan 120 which receives ambient air 122, a compressor section 123 including a low pressure compressor 124 and a high pressure compressor 126, a combustion chamber 130, a high pressure turbine 132, a low pressure turbine 134, and a nozzle 136 from which combustion gases are discharged from the engine 100. The high pressure turbine 132 is joined to the high pressure compressor 126 by a high pressure shaft or rotor 140, while the low pressure turbine 134 is joined to both the low pressure compressor 124 and the fan 120 by a low pressure shaft 142. The low pressure shaft 142 is at least in part rotatably disposed co-axially with and radially inwardly of the high pressure shaft 140.

Turning now to FIG. 3, an example compressor section 123 is shown in greater detail. The compressor section 123 includes a surrounding wall or casing 150 having an inwardly facing surface 152 and an outwardly facing surface 154. A plurality of axially spaced rows of rotor blades 156 extend outwardly from the rotor 140 across the flow path into proximity with the casing 150. Each rotor blade 156 is generally contoured to an airfoil cross section and includes a leading edge 160 and a trailing edge 162.

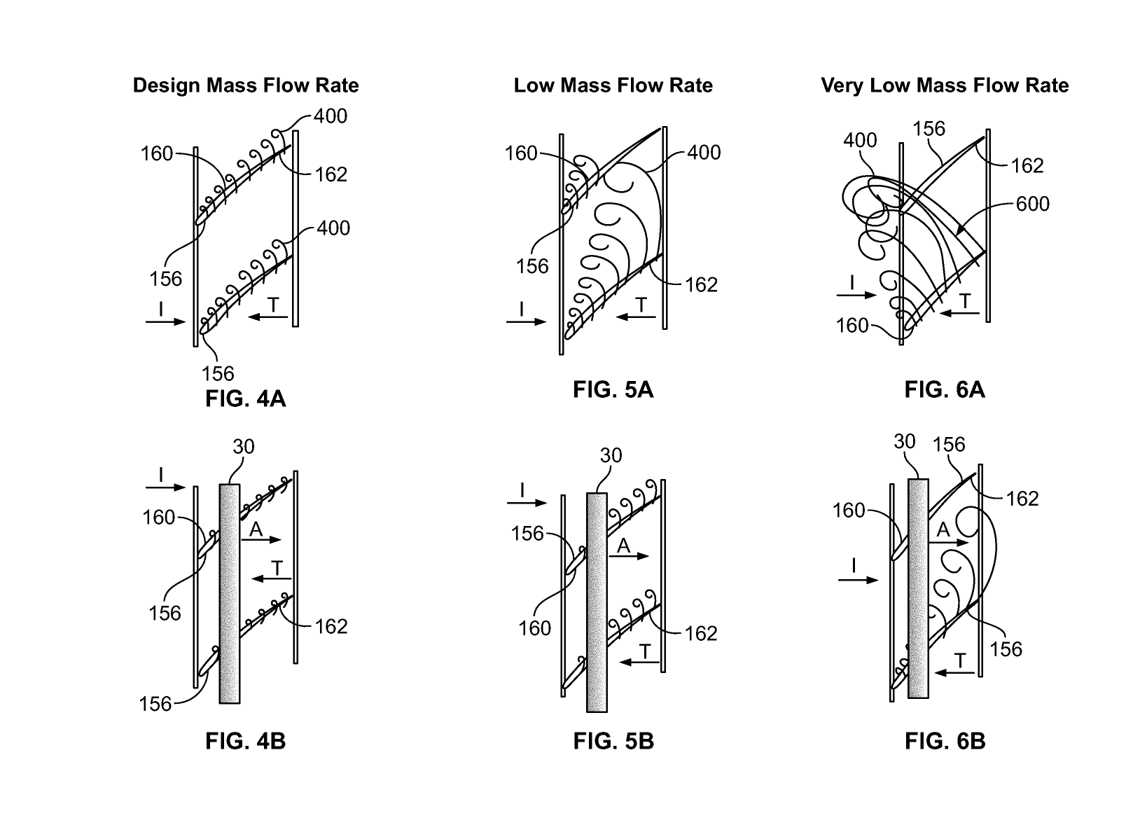

In the illustrated example of FIG. 3, a plurality of plasma actuators 10 are mounted circumferentially to the casing 150 in series. In this example, one of the electrodes 22 is embedded within the casing 150, while the other electrode 20 is mounted generally flush with or just below the inner surface 152 of the casing 150. In this configuration, when an AC electric field if applied, the plasma 30 forms on the inner surface 152 of the casing 150. In the illustrated example, an array of SDBD plasma actuators 10 are mounted in series and cover at least a portion of the inner surface of the casing 150. It will be understood, however, that the plasma actuators 10 may be strategically placed anywhere along the inner surface 152 of the casing 150, and in any arrangement. Furthermore, the plasma actuators may be located in any suitable location along the casing 150 or housing 110, including, for instance, proximate to the fan 120, turbines 132, 134, or any other location and may include as few as a single actuator. Still further, the actuators 10 may extend partially or completely around the circumference of the inner surface 152 to provide greater coverage of the surface 152 (see FIGS. 4B, 5B, 6B).

A schematic of the typical flow of the incoming ambient air 122 stream without any of the actuators 10 being energized is shown in FIGS. 4A, 5A, and 6A. In FIGS. 4A, 5A, and 6A, the typical flow of the ambient air 122 is illustrated at a design mass flow rate, a low mass flow rate, and a very low mass flow rate, respectively. As shown, as the flow rate transitions from a design mass flow rate (FIG. 4A) to a very low mass flow rate (FIG. 6A), the resulting flow is characterized by the formation of unsteady large-scale vorticies 400 being shed off the rotor blade 156, especially proximate the trailing edge 162. As the mass flow rate decreases, the vorticies 400 subsequently form a fully stalled flow 600, causing the blades 156 to experience a rotational stall.

A schematic of the typical flow of the incoming ambient air 122 stream with at least one circumferentially extending actuator 10 being energized is shown in FIGS. 4B, 5B, and 6B. In operation, the plasma actuator 10 is subjected to the ambient air 122 stream and is energized by the power supply 28. In the examples shown in FIGS. 3, 4B, 5B, and 6B, the electrodes 20, 22 are energized so as to give rise to an actuator induced flow A in the direction of the incoming flow I, and opposite to the tip clearance flow T or (e.g., the formed vorticies 400) (see FIG. 3). This serves to delay and/or prevent the formation of a fully stalled flow 600. In this manner the plasma actuator 10 gives rise to a plasma induced flow which will reduce the tip incidence of the rotor blade.

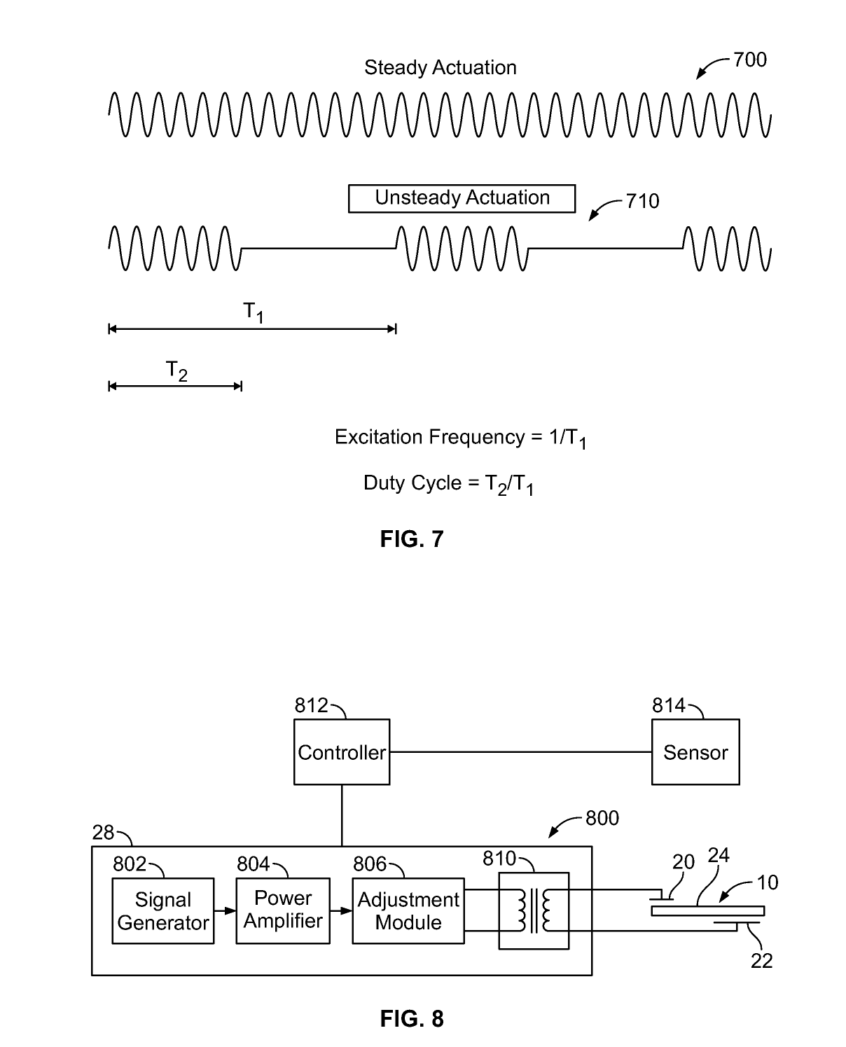

The example SDBD plasma actuator 10 utilizes an AC voltage power supply 28 for its sustenance. However, if the time scale associated with the AC signal driving the formation of the plasma 30 is sufficiently small in relation to any relevant time scales for the flow, the associated body force produced by the plasma 30 may be considered effectively steady. However, unsteady actuation may also be applied and in certain circumstances may pose distinct advantages. Signals for steady versus unsteady actuation are contrasted in FIG. 7. In the illustrated example, an example steady actuation signal 700 in comparison with an unsteady actuation signal 710. Both the steady actuation signal 700 and the unsteady actuation signal 710 utilize the same high frequency sinusoid. Referring to the figure, it is apparent that with regard to the unsteady actuation signal 710, during time interval T₁ the plasma actuator 10 is on only during the sub-interval T₂. Hence, the signal sent to the actuator 10 has a characteristic frequency of f=1/T₁ that will be much lower than that of the sinusoid and will comparable to some relevant frequency of the particular flow that one wishes to control. In addition, an associated duty cycle T₂/T₁ may be defined. It will be understood that the frequency and duty cycle may be independently controlled for a given flow control application as desired.

FIG. 8 shows a sample circuit 800 used to create the high-frequency, high-amplitude AC voltage generated by the AC source 28. In this example, a low amplitude, sinusoidal waveform signal is generated by a signal generator 802. The generated signal is supplied to a power amplifier 804. The amplified voltage is then fed trough an adjustment module 806 into the primary coil of a transformer 810. The high voltage output for the excitation of the plasma actuators 10 is obtained from the secondary coil of the transformer 810.

As noted above, the example plasma actuator 10 may be implemented in an open or closed loop for control of rotating stall. An example open loop implementation utilizes a controller 812 operatively coupled to the AC source 28 to energize or de-energize the plasma actuator 10 based upon the corrected speed and corrected mass flow of the compressor. An example closed loop implementation utilizes a sensor 814 mounted within the casing 150, proximate the inner surface of the casing 152, and/or exposed to fluid flow to monitor the compressor aerodynamics. The example sensor 814 is operatively coupled to the controller 812 to synthesize a stability state variable. In either implementation, the controller 812 selectively energizes or de-energizes the plasma actuator 10 to drive the fluid flow away from stall.

Although the teachings of the present disclosure have been illustrated in connection with certain examples, there is no intent to limit the disclosure to such examples. On the contrary, the intention of this application is to cover all modifications and examples fairly falling within the scope of the appended claims either literally or under the doctrine of equivalents.

We claim:

1. An axial flow device tip gap flow control system comprising:
a rotor of blades, each blade having a leading edge and a trailing edge;
a housing surrounding the rotor of blades and having an inner wall;
at least one plasma generating device coupled to the inner wall of the housing and circumscribing at least a portion of the rotor of blades; and
a power supply electrically coupled to the at least one plasma generating device such that when the power supply energizes the at least one plasma generating device, the axial momentum of a fluid flow between the inner wall of the housing and the tips of the rotor of blades in increased in the direction of the leading edge to the trailing edge.

2. A tip gap flow control system as defined in claim 1, wherein the at least one plasma generating device is a single dielectric barrier discharge plasma actuator.

3. A tip gap flow control system as defined in claim 1, wherein the at least one plasma generating device is mounted substantially perpendicular to the direction of the fluid flow.

4. A tip gap flow control system as defined in claim 1, wherein the at least one plasma generating device is flush with the inner wall of the housing.

5. A tip gap flow control system as defined in claim 1, further comprising a sensor to monitor the aerodynamics of the fluid flow.

6. A tip gap flow control system as defined in claim 5, wherein the sensor is operatively coupled to the power supply to cause the power supply to selectively energize and de-energize the at least one plasma generating device.

7. A tip gap flow control system as defined in claim 1, further comprising at least one second plasma generally serial located downstream from the at least one plasma generating device.

8. A tip gap flow control system as defined in claim 1, wherein the at least one plasma generating device extends substantially along the entire circumferential length of the inner wall of the housing.

9. A tip gap flow control system as defined in claim 1, wherein the plasma generating device is selectively energized and de-energized.

10. A tip gap flow control system as defined in claim 1, further comprising at least one array of plasma generating devices coupled to at least a portion of the inner wall of the housing and circumscribing at least a portion of the rotor of blades.

11. A compressor casing comprising:
an inner wall of the casing surrounding a rotor of blades;
at least one plasma generating device coupled to the inner wall of the casing and circumscribing the rotor of blades; and
a power supply electrically coupled to the at least one plasma generating device such that when the power supply energizes the at least one plasma generating device, the axial momentum of a fluid flow between the inner wall of the casing and the tips of the rotor of blades in increased in the direction of the fluid flow.

12. A compressor casing as defined in claim 11, wherein the at least one plasma generating device is a single dielectric barrier discharge plasma actuator.

13. A compressor casing as defined in claim 11, wherein the at least one plasma generating device is mounted substantially perpendicular to the direction of the fluid flow.

14. A compressor casing as defined in claim 11, wherein the at least one plasma generating device is flush with the inner wall of the casing.

15. A compressor casing as defined in claim 11, further comprising a sensor to monitor the aerodynamics of the fluid flow.

16. A compressor casing as defined in claim 15, wherein the sensor is operatively coupled to the power supply to cause the power supply to selectively energize and de-energize the at least one plasma generating device.

17. A compressor casing as defined in claim 11, further comprising at least one second plasma generally axially spaced downstream from the at least one plasma generating device.

18. A compressor casing as defined in claim 11, wherein the at least one plasma generating device extends substantially along the entire circumferential length of the inner wall of the casing.

19. A compressor casing as defined in claim 11, wherein the plasma generating device is selectively energized and de-energized.

20. A compressor casing as defined in claim 11, further comprising at least one array of plasma generating devices coupled to at least a portion of the inner wall of the casing and circumscribing at least a portion of the rotor of blades.

21. A plasma fairing as defined in claim 11, wherein the power supply generates an unsteady actuation signal.

22. A method of delaying the onset of rotational stall in a fluid flow through an axial compressor comprising;
coupling at least one plasma generating device to an inner surface of a housing at least partially surrounding a rotor of blades; and
energizing the at least one plasma generating device to produce a plasma when the body is subjected to a fluid flow.

23. A method as defined in claim 22, wherein the at least one plasma generating device is mounted substantially perpendicular to the direction of the fluid flow.

24. A method as defined in claim 22, further comprising selectively energizing the at least one plasma generating device.

25. A method as defined in claim 22, wherein energizing the at least one plasma generating device comprises generating an unsteady actuation signal and supplying the unsteady actuation signal to the plasma generating device.
